(19) United States
(12) Patent Application Publication
(10) Pub. No.: US 2021/0254891 A1
(43) Pub. Date: Aug. 19, 2021

(54) METHOD FOR AN IMPROVED PARTIAL CONDENSATION CARBON MONOXIDE COLD BOX OPERATION

(71) Applicants: Joseph Michael Schwartz, Williamsville, NY (US); Bryan S. Kalp, Grand Island, NY (US); Andrew M. Warta, Wheatfield, NY (US); Minish Mahendra Shah, East Amherst, NY (US)

(72) Inventors: Joseph Michael Schwartz, Williamsville, NY (US); Bryan S. Kalp, Grand Island, NY (US); Andrew M. Warta, Wheatfield, NY (US); Minish Mahendra Shah, East Amherst, NY (US)

(21) Appl. No.: 16/791,320

(22) Filed: Feb. 14, 2020

(51) Int. Cl. F25J 3/02; C01B 3/50

(52) U.S. Cl. CPC F25J 3/0223; C01B 3/506; F25J 2205/04; F25J 2245/02; F25J 2270/08; C01B 2203/046; C01B 2203/047; F25J 2270/04

(57) ABSTRACT

The present invention is directed to a method and system of separating carbon monoxide from syngas mixtures with high methane content by cryogenic means where a partial condensation cycle is generally employed, and more specifically towards combining the methane-rich liquid exiting the distillation column with a lower-boiling mixture so that the boiling point of the combined stream is lower than the boiling point of the methane-rich liquid.

### BACKGROUND OF THE INVENTION

### Field of the Invention

The present invention relates to a method of separating carbon monoxide from a synthesis gas containing hydrogen, carbon monoxide, methane, water, and carbon dioxide. More specifically, the invention is directed to a method of separating carbon monoxide from syngas mixtures with high methane content by cryogenic means where a partial condensation cycle is typically not employed, and more specifically towards mixing a methane-rich stream exiting the bottom of a distillation column that separates carbon monoxide and methane with a stream that has a lower boiling point before the combined stream enters a heat exchanger so that the boiling point of the combined stream is lower than the boiling point of the original methane-rich stream. This change enables the use of a simpler, less expensive partial condensation process instead of a methane wash process for the same syngas feed.

### Description of Related Art

Hydrocarbons such as natural gas, naphtha, and liquefied petroleum gas (LPG) can be catalytically converted with steam or oxygen to obtain a synthesis gas (i.e., a mixture of hydrogen (H₂), carbon monoxide (CO), methane (CH₄), water (H₂O), and carbon dioxide (CO₂) commonly referred to as “syngas”). The reformer processes including reformation in a partial oxidation reformer or a steam methane reformer are well known, and they are typically utilized to obtain syngas that is ultimately utilized in the production of hydrogen or chemicals such as methanol and ammonia. Conventional techniques for the separation of CO from the rest of the syngas constituents have been known. For instance, cryogenic purification methods, such as partial condensation or scrubbing with liquid methane, known as a methane wash process, are well known techniques.

The syngas typically contains a significant amount of CO₂ and H₂O that must be removed, typically by condensing the water and removing the liquid, removing most of the carbon dioxide by amine absorption, and removing the remaining CO₂ and water in a temperature swing adsorption (TSA) unit, commonly referred to as a dryer. Carbon dioxide and water must be removed to very low levels, typically less than 50 ppb, to prevent them from freezing in a downstream process heat exchanger. The syngas can then be sent to a cryogenic separation unit known as a cold box for CO purification.

There are two common types of CO cold boxes, partial condensation and methane wash. This invention relates to partial condensation cold boxes in which the syngas feed is partially condensed in a heat exchanger and separated using a phase separator to separate most of the hydrogen in the feed from the condensed components. This process suffers from the limitation that it does not function properly if the cold box feed contains too much methane. When the methane is high, generally above about 2.5%, the load on the recycle compressor increases and single-pass CO recovery decreases to the extent that a more-expensive methane wash cold box is typically used.

U.S. Pat. No. 4,805,414 to Fisher discloses a partial condensation process for CO purification in which the methane exiting the bottom of the CO/CH₄ separation column is mixed with the entire flash gas stream before it enters the heat exchanger. The process described includes a portion of the crude hydrogen vapor stream exiting the high-pressure separator being mixed with the methane stream.

U.S. Pat. No. 5,609,040 to Billy et al. depicts a partial condensation process for CO purification in which the methane exiting the bottom of the CO/CH₄ separation column is mixed with nitrogen from a distillation column that removes said nitrogen from CO product and with crude hydrogen exiting the first separator as vapor. This process requires a nitrogen removal column and does not recover hydrogen byproduct.

U.S. Pat. No. 5,832,747 to Bassett et al. shows a partial condensation process for CO purification and syngas production in which the methane exiting the bottom of the CO/CH₄ separation column is mixed with an expanded vapor stream exiting a phase separator before it enters the heat exchanger. This stream is the result of a third separator in series following a second high-pressure separator in series following the first high-pressure separator. The processes described in U.S. Pat. No. 5,832,747 require multiple separators because 1:1 syngas is also produced.

U.S. Pat. No. 6,062,042 to McNeil et al. and U.S. Pat. No. 6,070,430 to McNeil et al. show partial condensation processes for CO purification in which the methane exiting the bottom of the CO/CH₄ separation column is mixed with nitrogen that results from a distillation column that separates CO product from nitrogen impurity.

U.S. Pat. No. 6,098,424 to Gallarda et al. depicts a partial condensation process for CO purification and syngas production in which the methane exiting the bottom of the CO/CH₄ separation column is mixed with the entire flash gas stream from the top of a stripping column. A process where only a portion of the flash gas stream is mixed is not considered.

U.S. Pat. No. 6,161,397 to McNeil et al. shows a partial condensation process for CO purification and syngas production in which the methane exiting the bottom of the CO/CH₄ separation column is mixed with a crude carbon monoxide stream that is heated before mixing.

U.S. Pat. No. 6,467,306 to McNeil is similar to U.S. Pat. No. 5,832,747. Both show partial condensation processes for CO purification in which the methane exiting the bottom of the CO/CH₄ separation column is mixed with a heated vapor stream from a separator before it enters the heat exchanger. However, the vapor stream in this process is the result of a second separator in series for the vapor portion of the feed. The process described in U.S. Pat. No. 6,467,306 uses multiple separators, which increase the capital cost of the process.

U.S. Pat. No. 6,568,206 to Scharpf shows a partial condensation process for CO purification in which the methane stream exiting the bottom of the CO/CH₄ separation column is mixed with a hydrogen stream that permeates a membrane before being cooled and expanded to provide additional refrigeration in the cold box. The process of the current invention does not involve a membrane and does not have a stream comparable to the expanded membrane permeate that is combined with the methane.

In the related art for CO production, there are several examples of mixing streams with lower boiling points with the methane stream from the bottom of the CO/CH₄ separation column, but none that uses only a portion of the lower boiling stream for the purpose of controlling the boiling point of the mixture to control where the stream boils in the heat exchanger. Furthermore, as shown in the comparative example, using only a portion of the lower boiling stream provides advantages over the prior art processes as described herein.

To overcome the disadvantages of the related art, it is an object of the present invention to provide an improved process and apparatus to overcome operating limitations caused by high methane in a partial condensation cold box feed while still maintaining high CO recovery.

It is an object of the invention to reduce compression power, particularly for streams recycled to the cold box.

It is another object of the invention to increase the operating range of a partial condensation cold box to allow for increased methane in the feed due to an upset in upstream processes while maintaining high CO recovery and throughput.

It is another object of the invention to achieve high recovery of hydrogen product. Hydrogen is a valuable byproduct of the processes disclosed in the present invention and the failure to recover it represents a significant economic disadvantage.

It is another object of the invention to minimize the amount of CO in the gas phase of the partially condensed syngas feed to reduce recycle compression power. This is done by minimizing its temperature exiting the heat exchanger and achieved by providing the coldest streams possible to the heat exchanger to cool the syngas feed.

It is another object of the invention to minimize the number of separators and the capital cost associated with them.

It is another object of the invention to provide a process that does not require a nitrogen removal column and the capital cost associated with the column.

It is another object of the invention to avoid the use of a membrane and the capital cost associated with it.

Other objects and aspects of the present invention will become apparent to one of ordinary skill in the art upon review of the specification, drawings and claims appended hereto.

### SUMMARY OF THE INVENTION

The invention applies to carbon monoxide separation from syngas using a cryogenic partial condensation process. Particularly in cases where the methane content of the syngas is above about 2.5%, partial condensation processes in the prior art suffer from low carbon monoxide recovery or high power consumption. The invention provides processes wherein the boiling point of the methane-rich liquid byproduct stream exiting the distillation column entering the cold end of the process heat exchanger is reduced, allowing for heat to be removed from the feed stream at a lower temperature, producing a partially condensed syngas with a lower temperature, increasing overall and per pass CO recovery while reducing recycle compression power.

The boiling point of the methane stream can be reduced by mixing it with a portion of the hydrogen-rich vapor stream exiting the high-pressure separator or a portion of the hydrogen-rich vapor stream exiting the low-pressure separation unit. This can significantly improve the performance and efficiency of the process heat exchanger.

### BRIEF DESCRIPTION OF THE FIGURES

The objects and advantages of the invention will be better understood from the following detailed description of the preferred embodiments thereof in connection with the accompanying figures wherein like numbers denote same features throughout and wherein:

FIG. 1 is a process flow diagram illustrating an embodiment of the present invention where a portion of the vapor stream produced by the low-pressure separation unit is mixed with the methane-rich liquid exiting the distillation column to produce a combined stream that boils at a lower temperature than the methane-rich liquid in the process heat exchanger; and

FIG. 2 is a process flow diagram illustrating an embodiment of the present invention where a portion of the vapor stream produced by the high-pressure separator is mixed with the methane-rich liquid exiting the distillation column to produce a combined stream that boils at a lower temperature than the methane-rich liquid in the process heat exchanger.

### DETAILED DESCRIPTION OF THE INVENTION

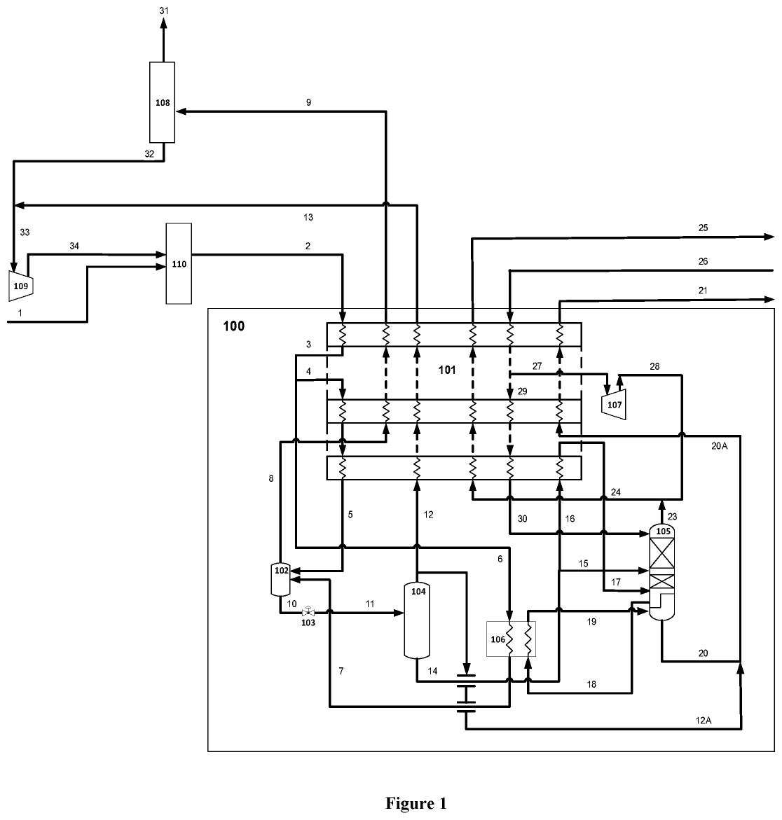

According to an aspect of the invention as shown in FIG. 1, a method for the separation of carbon monoxide from a syngas feedstock in a partial condensation carbon monoxide cold box is provided. The method includes:

A syngas feed (1) at near ambient temperature and elevated pressure, typically between 250 and 500 psig, is mixed with a high-pressure recycle (34), and fed to a dryer (110) that removes impurities including remaining water and carbon dioxide to produce a cold box feed (2). The cold box feed (2) enters a process heat exchanger (101) located inside a cold box (100) and exits the process heat exchanger (101) as a cooled cold box feed (3), typically between 130 and 140 K. The cooled cold box feed (3) is split into a partial condensation feed (4) and a reboiler feed (6). The partial condensation feed (4) is cooled further in the process heat exchanger (101) to a temperature typically between 85 and 95 K, so that part of the stream is condensed and exits the process heat exchanger as a partially condensed feed (5), which is fed to a high-pressure separator (102). The reboiler feed (6) provides heat to a reboiler (106) and exits the reboiler as a cooled reboiler feed (7), which is also fed to the high-pressure separator (102). The high-pressure separator (102) separates the mixtures fed into it to produce a high-pressure carbon monoxide-rich feed liquid (10) and a crude hydrogen vapor (8), which is warmed in the process heat exchanger (101) to produce a warmed crude hydrogen (9) that is subsequently fed to a pressure swing adsorption system (108).

The high-pressure carbon monoxide-rich feed liquid (10) is expanded across a valve (103) to produce a low-pressure separation unit feed (11) that is fed to a low-pressure separation unit (104), typically operating between 20 and 80 psig. The low-pressure separation unit (104) can be a single-stage separator vessel, a dual-stage separator, a multi-stage distillation or stripping column, or other means to remove most of the hydrogen contained in the low-pressure separation unit feed (11). In general, a separation unit with more stages would be expected to produce higher-purity CO product with less hydrogen, but would also have a higher capital cost. FIG. 1 shows a single-stage separator. Other streams would be required for a dual-stage separator or multi-stage column. Selection of the device used for the low-pressure separation unit (104) depends on the hydrogen purity requirement of the CO product. The low-pressure separation unit (104) produces a cold hydrogen-rich flash gas (12) and a crude CO liquid (14). A portion of the cold flash gas (12A) is mixed with a methane-rich liquid (20) described below. This portion of the cold flash gas (12A) ranges from about 1 to 99 volume percent, preferably 5-40 volume percent and most preferably 10-30 volume percent. The remainder of the cold flash gas (12) is warmed in the process heat exchanger (101) to produce a flash gas (13), which is typically near ambient temperature. The crude CO liquid (14) is divided into a direct column feed (15) and a liquid split feed (16). The direct column feed (15) is fed directly to a distillation column (105) while the liquid split feed (16) is at least partially vaporized in the process heat exchanger (101) to form a vaporized column feed (17), which is fed to the distillation column (105) at a location below the location of the direct column feed (15).

The distillation column (105) typically operates between 5 and 25 psig and separates the streams fed into it to produce a cold CO product (23), typically between 82 and 90 K, and a methane-rich liquid (20), typically between 105 and 110 K. A reboiler liquid stream (18) is removed from the distillation column (105) and heated in the reboiler (106) to produce a partially boiled bottoms (19) that is returned to the sump of the distillation column (105). The methane-rich liquid (20) is mixed with the portion of the cold flash gas (12A) to form a combined stream (20A). The boiling point of the combined stream (20A) is lower than the boiling point of the methane-rich liquid, so that it vaporizes at a lower temperature when heated and vaporized in the process heat exchanger (101) to produce a fuel gas (21).

The amount of the portion of the cold flash gas (12A) mixed with the methane-rich liquid (20) is determined by using the minimum necessary to provide the advantages of the present invention in the process heat exchanger (101). If not enough cold flash gas is mixed with the methane-rich liquid, the heat exchanger will be less effective and the temperature of the partially condensed feed (5), will be too high, resulting in unnecessary recycle flow and compression power. If too much cold flash gas is mixed with the methane-rich liquid, CO and hydrogen product will be lost without providing additional benefit in the process heat exchanger. This is shown in the comparative example described herein.

The cold CO product (23) mixes with a turbine exhaust (28) to form a combined cold CO product (24), which is heated in the process heat exchanger (101) to produce a warm CO product (25), which is typically compressed (not shown) and a portion removed at higher pressure as a recovered product. The remaining compressed warm CO product is recycled to the cold box as a CO recycle (26), typically between 100 and 300 psig. The CO recycle (26) can be at the same pressure as the recovered product or at a different pressure.

The CO recycle (26) is cooled in the process heat exchanger (101) and split into a turbine feed (27) and a warm CO reflux (29). The turbine feed (27), which is typically at a similar temperature to the cooled cold box feed (3) of between 125 K and 145 K, is expanded in a turbine (107) to produce the turbine exhaust (28), which is at lower pressure, typically at or slightly above the distillation column pressure of 5 to 25 psig, and lower temperature than the turbine feed (27), typically close to its dew point or possibly containing a small amount of liquid. The necessary refrigeration provided by the turbine can be supplied in other ways, including liquid nitrogen addition (not shown). The warm CO reflux (29) is cooled further and condensed in the process heat exchanger (101) to produce a cold CO reflux liquid (30), which is fed to the distillation column (105) as a reflux stream to improve cold CO product (23) purity.

The pressure swing adsorption system (108) produces a high-purity hydrogen product (31) and a tail gas (32). The tail gas (32) and the flash gas (13) are combined to produce a low-pressure recycle mixture (33). The low-pressure recycle mixture (33) is compressed in a recycle gas compressor (109) to produce the high-pressure recycle (34) that is mixed with syngas feed (1) and fed to the dryer (110).

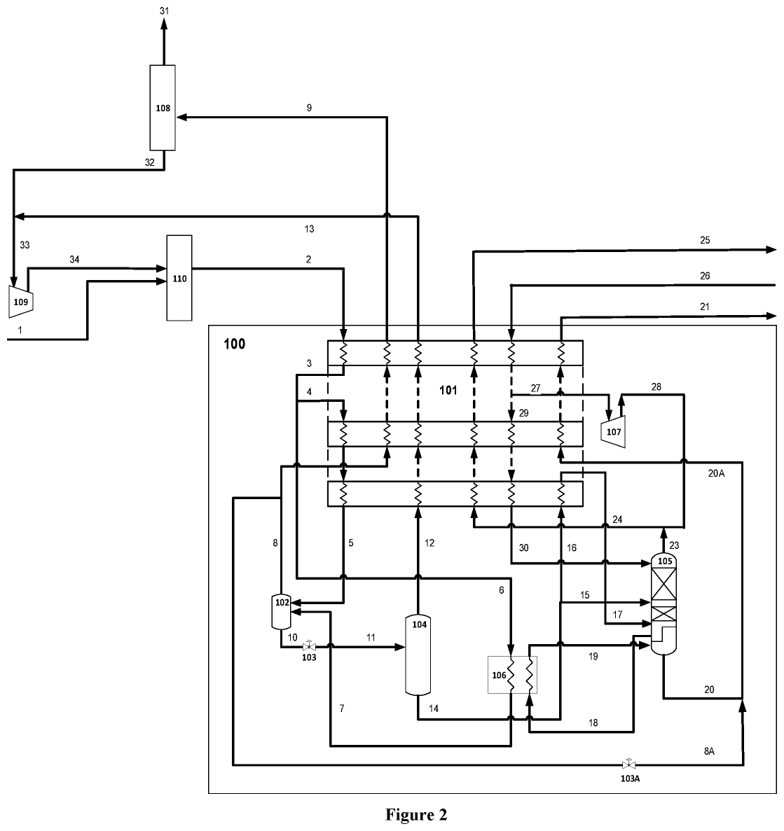

According to another aspect of the invention as shown in FIG. 2, a method for the separation of carbon monoxide from a syngas feedstock in a partial condensation carbon monoxide cold box is provided. In this case, a portion (8A) of the crude hydrogen vapor (8) is mixed with the methane-rich liquid (20) after it is expanded in a crude hydrogen vapor expansion valve (103A) to produce a combined stream (20A). This expansion reduces the pressure of the portion (8A) of the crude hydrogen vapor from about 250-500 psig to about 5-25 psig and reduces the temperature from about 85-95° K to about 75-90° K. This portion of the crude hydrogen (8A) ranges from about 0.5 to 99 volume percent, preferably 0.5-30 volume percent and most preferably 0.5-10 volume percent. The extent of cooling of the combined stream must be monitored carefully to ensure that methane in the combined stream does not freeze. The boiling point of the combined stream (20A) is lower than the boiling point of the methane-rich liquid, so that it vaporizes at a lower temperature when heated and vaporized in the process heat exchanger (101) to produce a fuel gas (21).

An important aspect of this invention is that it has higher CO recovery at lower power consumption when compared to alternative processes in the related art. This is accomplished by mixing the methane-rich liquid (20) with another stream that has a lower boiling point so that the boiling point of the combined stream is lower than the boiling point of the methane-rich liquid (20). This improves the effectiveness of the process heat exchanger (101) and reduces the temperature of the partially condensed feed (5), which reduces the quantity of the crude hydrogen vapor (8) and subsequent recycle compression power.

Another important aspect of the invention is that it enables operation of a partial condensation CO cold box for feeds with higher methane content, because of typical or unusual conditions, with higher recovery and lower power consumption than processes of the related art. These advantages are shown in the following example.

### Comparative Example

The process shown in FIG. 1 was modeled varying the split between the cold flash gas (12) and the portion (12A) mixed with the methane-rich liquid (20). Surprisingly, there is an optimum split for maximizing the total recovery of carbon monoxide product.

Table 1 shows the results. In Case 1, none of the cold flash gas was mixed with the methane-rich liquid. In Case 2, 20 volume % of the cold flash gas was mixed with the methane-rich liquid. In Case 3, all of the cold flash gas was mixed with the methane-rich liquid. Both Case 1 and Case 3 are provided as a comparison to demonstrate the advantages of the present invention. All cases had 4802 lbmol/hr of syngas feed with a composition of 65.83% hydrogen, 22.86% carbon monoxide, 11.10% methane, and 0.21% nitrogen at 100° F. and 361 psig. All cases produced carbon monoxide product that was at least 99% purity at 125 psig. All cases produced hydrogen product at 320 psig. All cases maintained a ΔT in the heat exchangers of at least 1 K.

TABLE 1

| | Compara- | | Compara- |
|---|---|---|---|
| Case | tive1 | 2 | tive3 |
| Syngas Feed (lbmol/hr) | 4802 | 4802 | 4802 |
| Syngas Feed Composition | | | |
| Hydrogen (mol %) | 65.83 | 65.83 | 65.83 |
| CO (mol %) | 22.86 | 22.86 | 22.86 |
| Methane (mol %) | 11.10 | 11.10 | 11.10 |
| Nitrogen (mol %) | 0.21 | 0.21 | 0.21 |
| CO Feed - Contained (lbmol/hr) | 1098 | 1098 | 1098 |
| CO Product - Contained (lbmol/hr) | 1030 | 1037 | 989 |
| CO Recovery (%) | 93.87 | 94.49 | 90.13 |
| H₂ Feed - Contained (lbmol/hr) | 3161 | 3161 | 3161 |
| H₂ Product (lbmol/hr) | 3161 | 3148 | 3099 |
| H₂ Recovery (%) | 99.98 | 99.57 | 98.04 |
| CO Compressor Power (kW) | 1598 | 1741 | 1510 |
| Recycle Compressor Power (kW) | 2932 | 2602 | 2360 |
| Total Compressor Power (kW) | 4530 | 4343 | 3870 |
| Crude H₂ - Total Flow (lbmol/hr) | 4410 | 4282 | 4213 |
| Crude H₂ - CO (mol %) | 14.88 | 12.85 | 12.80 |
| High-Pressure Separator Temp (K) | 94.25 | 92.27 | 92.28 |
| PSA Tail Gas Flow (lbmol/hr) | 1249 | 1134 | 1114 |
| Methane-Rich Liq./Mixt. Dew Pt. (K) | 114.4 | 114.2 | 112.4 |
| Methane-Rich Liq./Mixt. 10% Vapor | 107.3 | 104.3 | 98.8* |
| T (K) | | | |

*This stream enters the heat exchanger as 22% vapor at 98.8 K.

Comparing Case 1 with Case 2, the impact of mixing 20 volume % of the cold flash gas (12) with the methane-rich liquid (20) is that the performance of the process heat exchanger (101) improves significantly because the boiling point of the mixture is lower than the boiling point of the methane-rich liquid. This can be seen by comparing the temperatures at which 10% of the stream is a vapor. In Case 2, that temperature is 104.3° K while in Case 1, it is 107.3° K. This results in increased heat transfer at lower temperatures inside the process heat exchanger, resulting in a lower temperature in the high-pressure separator (102), 92.27° K vs. 94.25° K. The impact of a lower temperature in the high-pressure separator is that less CO leaves through the top of the separator with the crude hydrogen (8), resulting in less tail gas flow (32), 1134 lbmol/hr vs. 1249 lbmol/hr, and consequently, less recycle compressor flow and power, 2602 kW vs. 2932 kW.

In Case 1, where nothing is mixed with the methane-rich liquid, the impact on the heat exchanger extends to the distillation column (105). The temperature difference in the heat exchanger must be maintained by increasing the high-pressure separator temperature, as discussed above, and also by modifying the composition of the methane-rich liquid. In Case 2, the methane-rich liquid, which is typically used as a fuel stream, can contain 92% methane. In Case 1, the composition must be reduced to 89% methane to maintain ΔT in the heat exchanger, resulting in more carbon monoxide going to the fuel stream, reducing CO recovery from 94.49% to 93.87% for a total CO product loss of 7 lbmol/hr.

As shown in this comparison, Case 2, in which 20 volume % of the cold flash gas is mixed with the methane-rich liquid, has higher CO recovery and reduced compression power when compared to Case 1. This provides significant advantages over Case 1. Case 1 does recover more hydrogen, but because hydrogen is worth less than carbon monoxide on a volume basis, this advantage for Case 1 is not sufficient to overcome the reduction in CO recovery or increase in power required.

Comparing Case 2 with Case 3, the impact of mixing 20 volume % of the cold flash gas with the methane-rich liquid vs. mixing all of the cold flash gas is that the CO recovery, 94.49% vs 90.13%, and hydrogen recovery, 99.57% vs. 98.04%, are significantly higher in Case 2. This is because any CO and hydrogen contained in the cold flash gas that is mixed with the methane-rich liquid is lost to fuel and not recovered as product. Although the compressor power for Case 3 is lower, 3870 kW vs. 4343 kW, because there is less recycle flow, the loss of CO (4.6% less) and hydrogen (1.6% less) product significantly outweighs the power saved. Therefore, Case 2 also has significant advantages over Case 3.

Combining the crude hydrogen with the methane-rich liquid has a similar impact. If none is mixed, as shown in Case 1 above, the performance of the heat exchanger suffers, leading to a higher high-pressure separator temperature. This scenario also requires the distillation column to operate with more CO product lost to the methane-rich liquid. If all of the crude hydrogen stream is mixed, the loss of hydrogen product makes it cost prohibitive in any situation where the hydrogen product has any value. Typically, only a few percent of the crude hydrogen stream needs to be mixed with the methane-rich liquid to provide a benefit similar to what is seen in Case 2 above.

While the invention has been described in detail with reference to specific embodiments thereof, it will become apparent to one skilled in the art that various changes and modifications can be made, and equivalents employed, without departing from the scope of the appended claims.

What is claimed is:

1. A method for the separation of carbon monoxide from a syngas feedstock in a partial condensation carbon monoxide cold box, comprising:
cooling and partially condensing the syngas feedstock containing carbon monoxide and hydrogen in a process heat exchanger to produce a cooled and partially condensed syngas feed stream;
separating the cooled and partially condensed syngas feed stream into a crude hydrogen vapor stream and a high-pressure carbon-monoxide-rich feed liquid stream in a high-pressure separator;
feeding the high-pressure carbon-monoxide-rich feed liquid stream to a low-pressure separation unit operating at a pressure lower than the high-pressure separator, wherein a cold flash gas is separated from a crude CO liquid stream;
separating said crude CO liquid stream in a distillation column to form a purified carbon monoxide vapor stream and a methane-rich liquid byproduct stream containing at least 50% methane;
separating a portion of the cold flash gas having at least 1 vol % and less than 99 vol % and mixing said portion of cold flash gas with the methane-rich liquid byproduct stream before introducing the mixture into the process heat exchanger.

2. The method of claim 1 wherein 5-40 vol % of the cold flash gas is mixed with the methane-rich liquid before introducing the mixture into the process heat exchanger.

3. The method of claim 1 wherein 10-30 vol % of the cold flash gas is mixed with the methane-rich liquid before introducing the mixture into the process heat exchanger.

4. The method of claim 1, further comprising: warming the crude hydrogen stream in the process heat exchanger and then feeding it to a pressure swing adsorption unit for further purification, wherein the tail gas is recycled to the cold box.

5. The method of claim 1, wherein the portion of the cold flash gas not mixed with methane-rich liquid is warmed in the process heat exchanger and recycled to the cold box.

6. A method for the separation of carbon monoxide from a syngas feedstock in a partial condensation carbon monoxide cold box, comprising:
cooling and partially condensing the syngas feedstock containing carbon monoxide and hydrogen in a process heat exchanger to produce a cooled and partially condensed syngas feed stream;
separating the cooled and partially condensed syngas feed stream into a crude hydrogen vapor stream and a high-pressure carbon monoxide-rich feed liquid stream in a high-pressure separator;
feeding the high-pressure carbon monoxide-rich feed liquid stream to a low-pressure separation unit operating at a pressure lower than the high-pressure separator, wherein a cold flash gas is separated from a crude CO liquid stream;
separating said crude CO liquid stream in a distillation column to form a purified carbon monoxide vapor stream and a methane-rich liquid byproduct stream containing at least 50% methane;
wherein a portion of at least 0.5 vol % and less than 99 vol % of the crude hydrogen vapor stream is mixed with the methane-rich liquid before introducing the mixture into the process heat exchanger and none of the remaining crude hydrogen is expanded in a turboexpander.

7. The method of claim 6 wherein 0.5-30 vol % of the crude hydrogen vapor is mixed with the methane-rich liquid before introducing the mixture into the process heat exchanger.

8. The method of claim 6 wherein 0.5-10 vol % of the crude hydrogen vapor is mixed with the methane-rich liquid before introducing the mixture into the process heat exchanger.

9. The method of claim 6, further comprising: warming the portion of the crude hydrogen stream not mixed with the methane-rich liquid in the process heat exchanger and then feeding it to a pressure swing adsorption unit for further purification, wherein the tail gas is recycled to the cold box.

10. The method of claim 6, wherein the cold flash gas is warmed in the process heat exchanger and recycled to the cold box.

11. The method of claim 6, wherein the portion of the crude hydrogen vapor mixed with the methane-rich liquid is expanded before mixing, reducing its pressure and temperature.

12. An apparatus for the separation of carbon monoxide from a syngas feedstock in a partial condensation carbon monoxide cold box, comprising:
a process heat exchanger;
a high-pressure separator;
a low-pressure separation unit operating at a pressure lower than the high-pressure separator;
a distillation column for separating a crude CO liquid stream to form a purified carbon monoxide vapor stream and a methane-rich liquid byproduct stream containing at least 50% methane;
a turbine for providing refrigeration;
at least two connected lines to combine the methane-rich liquid byproduct stream with a portion of a stream produced in the cold box that has a lower boiling point prior to introducing a combined stream into the process heat exchanger.

13. The apparatus of claim 12, wherein the combined stream comprises a portion of the cold flash gas.

14. The apparatus of claim 13, wherein 5-40 vol % of the cold flash gas is mixed with the methane-rich liquid prior to introducing the combined stream into the process heat exchanger.

15. The apparatus of claim 13, wherein 10-30 vol % of the cold flash gas is mixed with the methane-rich liquid prior to introducing the mixture into the process heat exchanger.

16. The apparatus of claim 12, wherein the combined stream is a mixture of methane-rich liquid byproduct and a portion of the crude hydrogen vapor stream.

17. The apparatus of claim 16, wherein 0.5-30 vol % of the crude hydrogen vapor stream is mixed with the methane-rich liquid prior to introducing the mixture into the process heat exchanger.

18. The apparatus of claim 16, wherein 0.5-10 vol % of the crude hydrogen vapor stream is mixed with the methane-rich liquid prior to introducing the mixture into the process heat exchanger.
